(19) United States
(12) Patent Application Publication
(10) Pub. No.: US 2010/0210981 A1
(43) Pub. Date: Aug. 19, 2010

(54) SLIMMING APPARATUS THAT OPERATES BY IMPROVING CUTANEOUS CIRCULATION

(76) Inventor: Werner Hofmann, Salzburg (AT)

Correspondence Address: LERNER GREENBERG STEMER LLP, P O BOX 2480, HOLLYWOOD, FL, 33022-2480, US

(21) Appl. No.: 12/672,019

(22) PCT Filed: May 24, 2007
(86) PCT No.: PCT/AT07/00247

§ 371 Date: Feb. 3, 2010

(30) Foreign Application Priority Data
Jun. 1, 2006 (AT) A 955/2006

(51) Int. Cl. A61H 7/00

(52) U.S. Cl. 601/152

(57) ABSTRACT

A slimming apparatus operates by improving cutaneous circulation during activity in the fat burning pulse range carried out on endurance training equipment. The apparatus includes a main body with a fastening element in the form of a cuff which has at least two chambers that are independent of one another and that can be supplied with a fluid independent of one another. A simple configuration and high therapeutic effect can be achieved in such a way that a first chamber consists of a first main section which is arranged in a substantially linear fashion, with several first branch sections branching off from said main section. A second chamber consists of a second main section, with several second branch sections branching off from said section, which second sections are each arranged between the first branch sections. The apparatus can be attached to different body parts and includes a belt which is arranged with at least two chambers which are independent from one another. The apparatus further includes one pump for generating the alternating pressure load and a fastening cuff which press the basic body onto the human body in order to start the operation of the pressure chamber.

The present invention relates to a slimming apparatus that operates by improving cutaneous circulation during activity in the fat burning pulse range carried out on endurance training equipment, comprising a main body with a fastening element in the form of a cuff which has at least two chambers that are independent of one another and that can be supplied with a fluid independent of one another. This apparatus is intended to achieve slimming of persons in their problem areas by improving circulation in problem areas during activity in the fat burning pulse range. This occurs by means of an alternating pressure load in the region of the problem areas. The apparatus can be attached to different parts of the body and comprises a belt which is arranged with at least two chambers which are independent of one another, at least one pump for generating an alternating pressure load, and a cuff which presses the main body against the human body in order to make the pressure chamber work.

EP 1 248 586 B1 relates to a fitness device in the form of a garment where a low-pressure chamber is provided mandatorily.

A further training device is known from EP 1 307 168 B1 which represents a training apparatus with a rigid housing in which a negative pressure can also be produced.

It is further known from WO 03/030808 A to compose a fitness device in the form of a cuff which comprises several air chambers which can be provided with overpressure and low pressure in an alternating fashion. The air chambers are supplied via separate feed lines through which air is supplied or removed periodically.

Similar solutions are known from WO 01/52787 A, WO 04/084790 A and US 2005/0187500 A.

Such training devices are relatively complex and limited in respect of their area of application because only a certain working frequency can be achieved with an acceptable amount of effort. Preferably, personal attendance is necessary which is provided in fitness and recreational businesses.

None of the known training apparatuses can fulfill the following requirements sufficiently, which simultaneously form the objects of the present invention:
Simple and cost-effective configuration
High efficiency
Simple cleaning of the used parts
Easy to operate
Compact with low weight
Mobile application
No service required
Target group is the final consumer: at home, outdoors and for travelers
Low purchase price
Expandable set: one pump works with all three apparatuses

It is the object of the present invention to provide an apparatus which offers the advantages as mentioned above.

These objects are achieved in accordance with the invention in such a way that a first chamber consists of a first main section which is arranged in a substantially linear fashion, with several first branch sections branching off from the same, and a second chamber consists of a second main section, with several second branch sections branching off from the same which are each arranged between the first branch sections. The relevant aspect in the present invention is the fact that only a relatively small number of mutually independent chambers are present which have a mutually toothed arrangement, so that large flow cross sections are available for distribution within the chambers which ensure an even and rapid distribution of the compressed air. As a result, high frequencies can be realized with which the chambers can be supplied and relieved. Air or a viscous fluid can be used as the flow medium. As a result of the pressure loading of the belt, the tissue disposed beneath the belt is stimulated in a virtually simultaneous manner, so that high therapeutic effect is achieved. Moreover, the apparatus in accordance with the invention has an especially simple configuration and can therefore be produced at low cost.

An especially simple and effective configuration can be achieved in such a way that the main sections extend in a straight line and parallel. The main sections are provided in an especially preferable way along a circumferential edge of this apparatus. This means that the apparatus itself is arranged in a substantially cylindrical manner and the main sections extend along the two edges of the cylinder. This means that the apparatus itself is arranged in a substantially cylindrical way and the main sections extend along the two edges of the cylinder. The branch sections are arranged in an especially preferred manner rectangularly in relation to the main sections.

A first preferred embodiment of the invention provides that a pump is provided which can be switched over to the various chamber systems or can be controlled automatically. A single pump is then sufficient.

The application of the apparatus, especially during travelling, can be ensured in an especially advantageous embodiment in such a way that the apparatus is portable by means of a mobile power supply and comprises at least one pump. It is also possible to attach the pump externally. Special treatment concepts can be realized in such a way that more than two chambers are provided which can be brought from the normal pressure state to the slightly overpressure state. It is preferable when the chambers have a double-wall, water-impermeable cover which is flexible in sections. This apparatus fulfils its goal only in conjunction with activity in the fat burning pulse range with all endurance training machines (bike, treadmill, steppers, etc.).

The present invention is now explained in closer detail below by reference to the embodiments shown in the drawings, wherein:

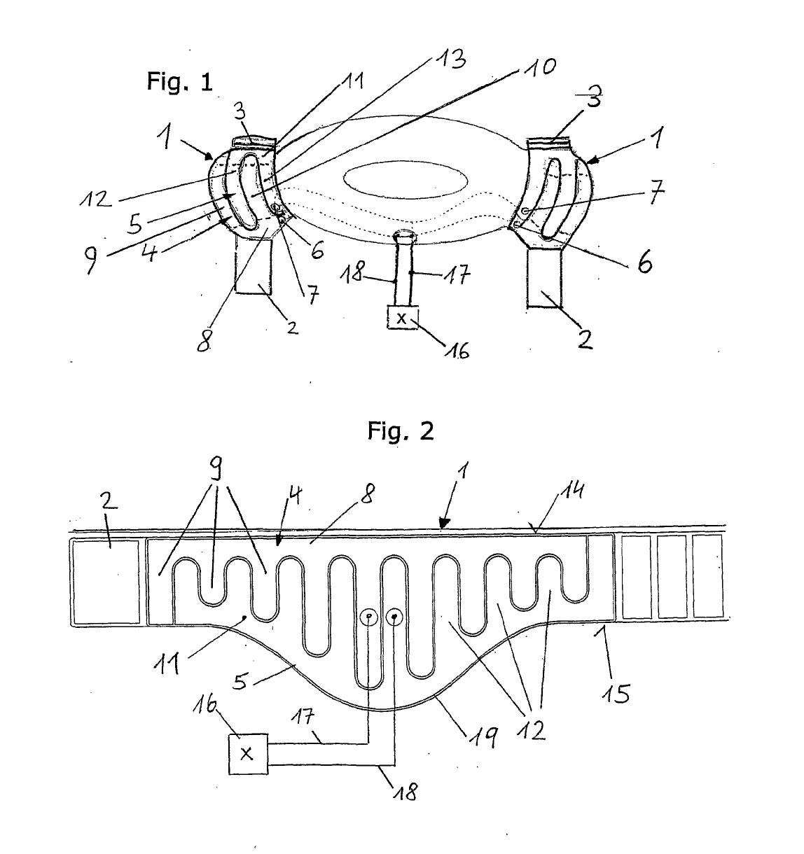

FIG. 1 shows a first embodiment of the invention;

FIG. 2 shows a second embodiment of the invention, and

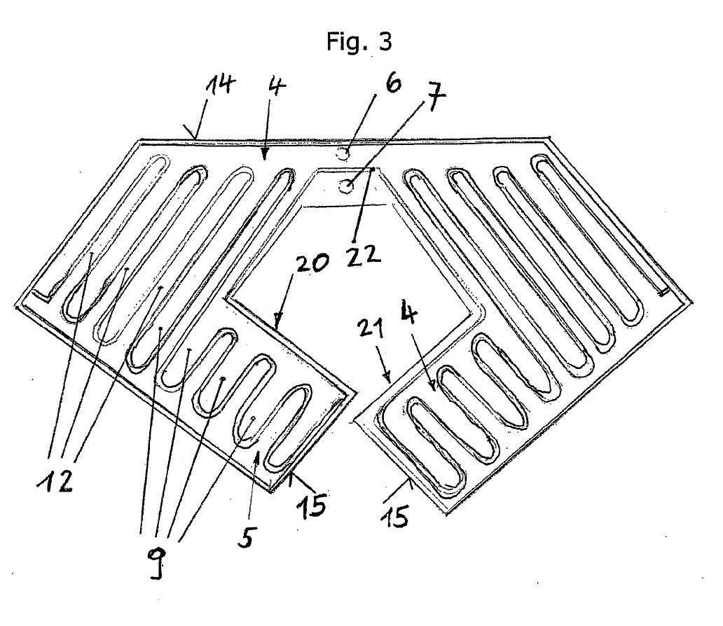

FIG. 3 shows a third embodiment of the invention, each in a schematic view.

The embodiment of FIG. 1 is an apparatus for treating the upper arms. It consists of a main body 1 on which a cuff 2 is formed, with a strap 3 being formed on the opposite part of the cuff as a Velcro fastener 2 on the main body 1, which strap can be connected with the cuff of the Velcro fastener 2 in the known manner in order to fasten the apparatus (sphygmomanometer).

The apparatus comprises a first chamber 4 and a second chamber 5 which can each be supplied with compressed air or another viscous fluid via the feed openings 6, 7. The first chamber 4 consists of a first main section 8 and two branch sections 9, 10 which are separated by broken lines for illustration in FIG. 1. In an analogous manner, the second chamber 5 consists of a second main section 11 and two branch sections 12, 13 which are also separated from one another in the illustration by a broken line. As a result of the large flow connection between the main sections 8, 11 and the branch sections 9, 10; 12, 13, the chambers 4, 5 can be supplied rapidly with compressed air or any other medium and can also be discharged rapidly again. High frequencies in the alternating filling and discharging of the chambers 4, 5 can thus be achieved. In the embodiment of FIG. 1, the main sections 8; 11 of the chambers 4, 5 are substantially parallel to the axis of the upper arm during use and the branch sections 9, 10; 12, 13 extend substantially in the circumferential direction. The supply of the apparatus via lines 17, 18 by a pump 16 that can be loaded in an alternating manner is shown schematically, which lines open into the first and second chamber 4, 5. In order to enable the correct positioning and fastening of the two cuffs 2 on the body, a shoulder part (like a pullover) made of neoprene is sewed in between. The connecting tubes are joined with connection elements on two valve outputs in the breast part.

FIG. 2 shows an alternative embodiment of the invention which can also be used as an apparatus for the stomach area. For reasons of simplicity, merely the main body 1 is shown. The fastening can occur as shown in FIG. 1 or be provided with a Velcro fastener 2. In this embodiment, the main sections 8; 11 of the chambers 4, 5 are arranged along the circumferential edges 14, 15 of the main body 1. The branch sections 9; 12 are arranged in a rectangular manner in relation to the main sections 8; 11 and extend in the application situation substantially parallel to the axis of the respective body part. The illustration schematically shows the supply of the apparatus by a pump 16 that can be loaded in an alternating manner via lines 17, 18 which open into the first and second chamber 4, 5. FIG. 2 further shows that the circumferential edges need not necessarily be arranged in a straight line, but can also have convex sections 19 for example.

FIG. 3 shows an alternative embodiment of the apparatus in accordance with the invention which is arranged in the form of a trouser belt. The first chamber 4 extends substantially parallel to the upper circumferential edge 14 which is arranged approximately in the belt region during use. The second chamber 5 extends at the bottom edge 15 of the trouser legs which are designated here generally with reference numerals 20, 21. A connecting section 22 produces the pneumatic or hydraulic separation of the individual parts of the second chamber 4, 5. The branch sections 9; 12 extend substantially parallel or in a meandering fashion in relation to the axis of the trouser legs 20, 21. FIG. 3 shows that respective deviations are possible as a result of the fit. Velcro elements which are not shown in FIG. 3 allow applying the trouser belt before use in a respectively tight manner on the body of the person in order to ensure the therapeutic effect of the alternating pressure loading. In addition, neoprene trousers are donned in order to ensure even pressure effect.

The present invention allows providing an apparatus which has a simple configuration and ensures high therapeutic effect within the terms of increasing blood circulation as a result of alternating pressure loading with respective frequency. In addition, this effect is achieved by activity with endurance training machines in the fat burning pulse range.

1-18. (canceled)

19. A slimming apparatus that operates by improving cutaneous circulation during activity in the fat burning pulse range carried out on endurance training equipment, comprising a main body with a fastening element in the form of a cuff which has at least two chambers that are independent of one another and that can be supplied with a fluid independent of one another, characterized in that a first chamber consists of a first main section which is arranged in a substantially linear fashion, with several first branch sections branching off from said main section, and a second chamber consists of a second main section, with several second branch sections branching off from said section, which second sections are each arranged between the first branch sections.

20. An apparatus according to claim 19, characterized in that the main sections extend in a straight line and parallel.

21. An apparatus according to claim 20, characterized in that the main sections are each arranged along a circumferential edge of the cuff.

22. An apparatus according to claim 19, characterized in that the branch sections are disposed in a rectangular manner in relation to the main sections.

23. An apparatus according to claim 19, characterized in that a pump is provided which can be switched over automatically to the chambers.

24. An apparatus according to claim 19, characterized in that each chamber is in connection with a separate pump.

25. An apparatus according to claim 19, characterized in that the apparatus is portable by means of a mobile power supply and comprises at least one pump.

26. An apparatus according to claim 19, characterized in that the pump is attached externally.

27. An apparatus according to claim 19, characterized in that more than two chambers are provided which are transferred from the normal pressure state to a slight overpressure state.

28. An apparatus according to claim 19, characterized in that no negative pressure is required in the chambers without any exceptions.

29. An apparatus according to claim 19, characterized in that only overpressure is used in the chambers without any exceptions.

30. An apparatus according to claim 19, characterized in that the main body wraps around a body part and is arranged with a fastener which is arranged as a fastening cuff.

31. An apparatus according to claim 19, characterized in that the chambers have a double-wall, water-impermeable cover which is flexible in sections.

32. An apparatus according to claim 19, characterized in that the apparatus for achieving the pressure loading uses air as the transport medium.

33. An apparatus according to claim 19, characterized in that the apparatus for achieving the pressure loading uses a viscous fluid as the transport medium.

34. An apparatus according to claim 19, characterized in that the apparatus for achieving the desired shaping of individual sections of the body is arranged as a trouser belt, thigh cuff or sweat slacks.

35. An apparatus according to claim 19, characterized in that the apparatus for achieving the desired shaping of individual sections of the body is arranged as an upper arm cuff or belt.

36. An apparatus according to claim 19, characterized in that the apparatus for achieving the desired shaping of individual sections of the body is arranged as a waist or kidney belt.
